(19) United States
(12) Patent Application Publication
(10) Pub. No.: US 2021/0295405 A1
(43) Pub. Date: Sep. 23, 2021

(54) SYSTEM AND METHOD OF UNIVERSAL ACCOUNT, TRANSFER, PROCESS, AND AUTHENTICATION OF A FINANCIAL TRANSACTION

(71) Applicant: Bihama Vedaste, San Jose, CA (US)

(72) Inventor: Bihama Vedaste, San Jose, CA (US)

(21) Appl. No.: 16/824,262

(22) Filed: Mar. 19, 2020

(51) Int. Cl. G06Q 30/06; G06F 16/9535; G06Q 10/08; G06Q 40/02; G06Q 30/00; G06Q 20/40

(52) U.S. Cl. CPC G06Q 30/0609; G06F 16/9535; G06Q 10/087; G06Q 30/0605; G06Q 30/0635; G06Q 20/4016; G06Q 30/0627; G06Q 40/02; G06Q 10/083; G06Q 30/0185; G06Q 30/0631

(57) ABSTRACT

A system for universal account, transfer, process, and authentication of a financial transaction is provided. The system receives a message from a client device associated with a customer seeking a product available from a plurality of online vendors and locates the product in at least one database associated with at least one of the online vendors. The system presents the product to the client device including identifying information about at least one vendor offering the product, and processes purchase instructions received from the client device. The product is presented without bias in favor of or bias against any vendor. The application provides options based on customer preferences. The system searches the at least one database based on filters configured by the customer.

### CROSS REFERENCE TO RELATED APPLICATIONS

The present disclosure is related to U.S. Provisional Patent Application No. 62/958,692 filed Jan. 8, 2020, the contents of which are included herein in their entirety.

### FIELD OF THE INVENTION

The present disclosure is in the field of transaction processing. More particularly, systems and methods described herein provide for consumers around the world to complete purchases and financial transactions without a cumbersome need for bank accounts, telephone numbers, and other established means of identification.

### BACKGROUND

Various systems and methods are presently available to facilitate money transfer, online shopping, and other electronic transactions. Sending funds using a mobile device and apps such as Venmo, Square, Western Union, and World Remit may require only an ID and a phone number to complete transactions.

Presently, one cannot send or receive funds when the counterparty does not have a bank account. Individuals cannot transact if they have no official identification such as a driver license or by simply using a telephone number. One cannot transact with a bank without an identification or a phone number.

No universal account is presently available that allows persons to send and receive money with a single identifying tool. Currently about two billion people worldwide have bank accounts but are unable to complete online transactions. Currently, about 1.7 billion people worldwide do not have bank accounts.

Western Union and Ria enable customers to send and receive funds contingent on their having identification such as a passport, national id or diplomatic documents using a registered agent. World Remit enables persons to send money using a mobile money transfer that is already in place using an app or website.

PayPal requires a bank account and an email address to become a customer. Visa, MasterCard and American Express insist that a customer use a card issued by them or a financial institution. American Express is for credit only. Some platforms accept visa or Mastercard or both while other accept these plus American Express. None of these vendors enables a universal form of online payment.

Apple Pay, Google Pay, and Samsung Pay, promise that a customer may purchase goods using a telephone. But the phone must be linked to a bank account.

Square and Venmo provide for funds to be exchanged between two account users. However, the users must have bank cards or accounts linked to the cards.

### BRIEF DESCRIPTION OF THE DRAWINGS

FIG. 1a is a block diagram of a system of universal account, transfer, process, and authentication of a financial transaction according to an embodiment of the present disclosure.

FIG. 1b is a process flow diagram of a method of universal account, transfer, process, and authentication of a financial transaction according to an embodiment of the present disclosure.

FIG. 2 is a process flow diagram of a method of universal account, transfer, process, and authentication of a financial transaction according to an embodiment of the present disclosure.

FIG. 3 is a process flow diagram of a method of universal account, transfer, process, and authentication of a financial transaction according to an embodiment of the present disclosure.

FIG. 4 is a legend of terms used in FIG. 3.

FIG. 5 is a process flow diagram of a method of universal account, transfer, process, and authentication of a financial transaction according to an embodiment of the present disclosure.

FIG. 6 is a legend of terms used in FIG. 5.

FIG. 7 is a process flow diagram of a method of universal account, transfer, process, and authentication of a financial transaction according to an embodiment of the present disclosure.

FIG. 8 is a process flow diagram of a method of universal account, transfer, process, and authentication of a financial transaction according to an embodiment of the present disclosure.

FIG. 9 is a legend of terms used in FIG. 8.

### DETAILED DESCRIPTION

Systems and methods described herein provide for universal account, transfer, process, and authentication of financial transactions that may facilitate consumer and other transactions regardless of parties' location or bank account status. In various embodiments, an application provided herein receives messages from client devices used by customers around the world. The customers may be seeking products available from at least one online vendor. The application provides customers at least one search function to search databases of online vendors.

The application locates the desired product in at least one database associated with at least one of the online vendors. The application presents the product, including names of offering vendors, to the client devices. When customers enter orders for products found by the application during searches of online vendors, the application processes purchase instructions associated with the entered orders.

Products are presented to customers without bias in favor of or bias against any vendor. The application provides options based on customer preferences and searches the at least one database based on filters configured by the customer. The filters are configured upon enrollment in a program administered by the application and not during searching.

The application tracks customer monetary amounts managed by the application as fiduciary on customers' behalf, the amounts held at multiple banks. When funding a vendor for a purchase by a customer, the application performs verification to ensure validity of customer and further requires involved banks to ensure said validity.

A portion of amount owed under an online purchase is paid when the purchase instructions are processed. A remaining portion of the amount owed is paid upon one of shipment of product and confirmation by shipping company.

Methods of accomplishing similar results as above are also provided. The application described above receives notification of a placement of a purchase order by a client device with an online retailer. The application remits, on behalf of the client device, a first portion of a total price of the order to either the retailer and a shipping company. When the order has shipped, the application receives notice and remits, on behalf of the client device, a remainder of the total price to either the retailer or the shipping company. When making remissions, the application performs verification to ensure validity of customer and further requires involved banks to ensure said validity.

In other embodiments, the application described above tracks, as noted, customer monetary amounts managed as fiduciary on customers' behalf, the amounts held at multiple banks. While tracking the amounts, the application moves funds between banks to facilitate online transactions between customers and vendors. When funding a vendor for a purchase by a customer, the application performs verification to ensure validity of customer and further requires involved banks to ensure that validity. The application also enforces a waiting period between payment of vendor and drawing on customer amounts to address risk of fraud.

Customers are issued cards that allow access to their monetary amounts overseen by the application. Customers deposit funds into their accounts at agencies associated with the application when in locations not served by banks. Customer accounts may be identified by telephone number.

Systems and Methods Described Herein Further Provide the Following:

1. Point of Sale: a customer can use without having a bank account. A phone number or identification number and a pin will suffice. Funds will be taken from a dedicated account provided herein.
2. Bank: a customer can deposit or withdraw without having a bank account. A phone number or id number for identification will suffice. The bank will take out or deposit money into a dedicated account provided by the application described above
3. Online shopping: at checkout, the customer using the client device transacts with the application described above, portions of which are embedded into the systems of online vendors. This will allow nearly any customer located nearly anywhere to shop whether or not they have an account with a bank.
4. Money transfer is nearly instant because customers will have a virtual worldwide bank account using systems provided herein. If a party transmits funds to another party, the transmission will go straight to the receiving party's account without middle men or agents using phone number or id number or other forms or identifier. The receiving party will have immediate access to the funds.
5. ATM: lost bank card, wallet or phone is not a problem. These may be replaced based solely on the customer's assigned identifier.
6. Transfer fees are minimal or nonexistent.
7. Risk of identity theft is reduced because systems provided herein transact on behalf of the customer in banks.
8. Risk of identity theft is further reduced because systems provided herein process transactions on behalf of customers like online transactions.

Online Shopping:

1. Systems and methods provided herein customize the customers' needs to their specifics of their size, preferred brands, and colors.
2. Systems and methods provided herein also bring in 3D and real time viewing of products before a customer completes a purchase. The customer receives an actual look of the product.
3. Live chat between seller and buyers is provided.
4. Systems provided herein prevent incorrect products being shipped by linking serial numbers to the shipping labels with large shipping companies
5. Payment does not take place until confirmation of shipping via seral numbers
6. Universal payment method online

Systems and methods described herein will provide banking services for the many people worldwide who cannot bank or use bank services and will allow them to shop both in stores and online. The present disclosure will facilitate easy exchange of money and currency with low or no handling fees.

Customer will be able to complete many types of transactions without the worry of identity theft and without concern for their data or financial records or account information being stolen. People may be able to shop online without a bank card will allow them to shop online even when their address system is different from that used in the Western hemisphere.

Systems and methods provided herein will allow people to shop online with actual image or quality. The present disclosure may improve shipping processes by linking serial number (or product identification number) to shippers and retailers and customers' customized preferences such as shoe size.

It will make online shopping less tedious by showing customers what they are looking for with their favorite brands. Further, it will make navigation into online stores much easier by showing customers what their relevant likings may be thus no issue of the plenty.

Systems and methods provided herein may be more appealing to users by providing a functional and intuitive interface. Systems and methods will bring vendor seller and buyer closer by three-dimension display of products, live chat or messaging.

Systems and methods provided herein may enable users to reduce of eliminate losses due to online fraud, as the system will pay the seller once a product is presented and shipped. It will provide universal form of payment in both off and online or in real life. It will make it easy to bank anywhere in the world. If a customer loses his/her identification, the problem will be resolved quickly.

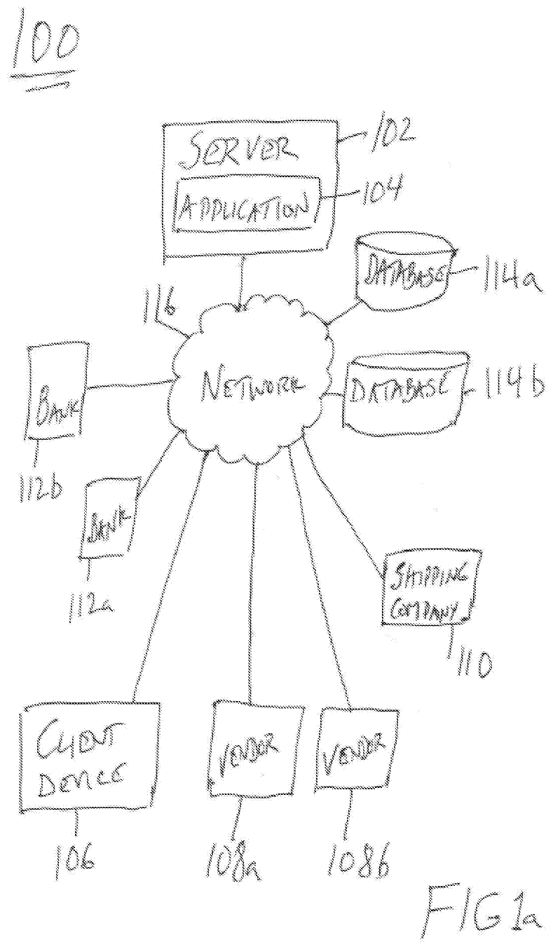

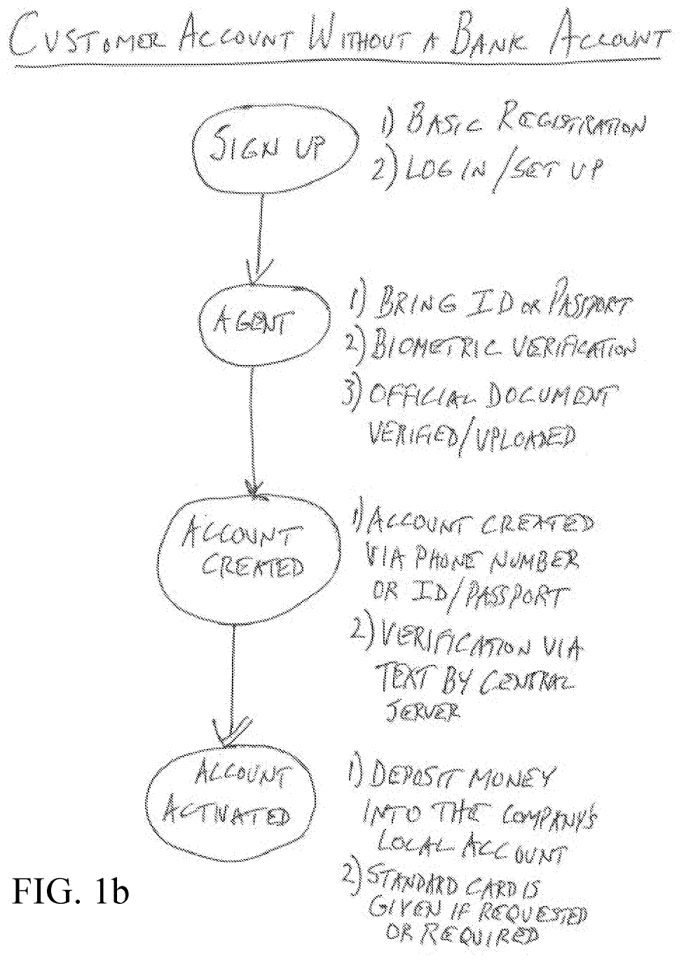

Turning to the figures, FIG. 1a is a block diagram of a system provided herein in accordance with various embodiment. FIG. 1a depicts components and relationships of a system 100. The system 100 comprises a server 102 and an application 104 executing at least partially thereon. A client device 106 is provided wherein in nearly all embodiments a plurality of such client devices 106 will be in effect.

Vendors 108a-b are provided as well, which in most embodiments are online vendors. The system 100 also comprises a shipping company 110 wherein in embodiments a plurality of shipping companies 110 are in effect Banks 112a-b are also provided as well as databases 114a-b and a network 116.

The application 104 executes most of the actions of the system 100 in terms of acting as a fiduciary for funds placed with it by customers using client devices 106. The application 104 may move customer funds between banks 112a-b to facilitate completion of transactions. The databases 114a-b may be proprietary to vendors 108a-b or they may be owned and/or operated by parties independent of vendors 108a-b whose products are sold via the databases 114a-b. The network 116 may be any private or public electronic network including the world wide web of the public Internet.

FIG. 1b is a process flow diagram of a method of universal account, transfer, process, and authentication of a financial transaction according to an embodiment of the present disclosure. FIG. 1b depicts steps for a customer who does not have a bank account to enroll in programs provided herein and have his/her account activated.

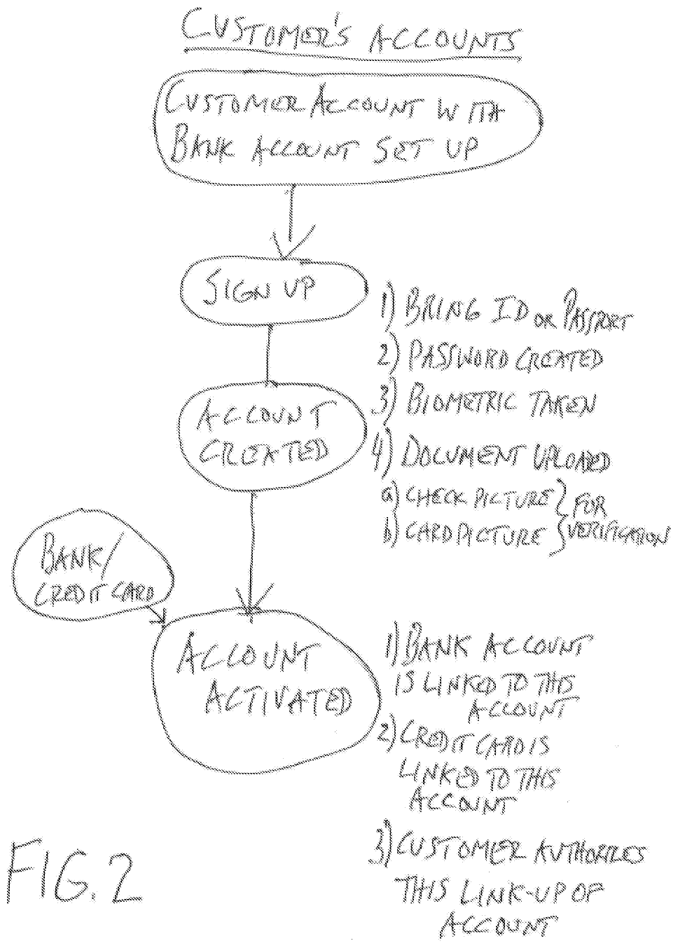

FIG. 2 is a process flow diagram of a method of universal account, transfer, process, and authentication of a financial transaction according to an embodiment of the present disclosure. FIG. 2 depicts the steps for a customer who does have a bank account to enroll in programs provided herein and receive full activation.

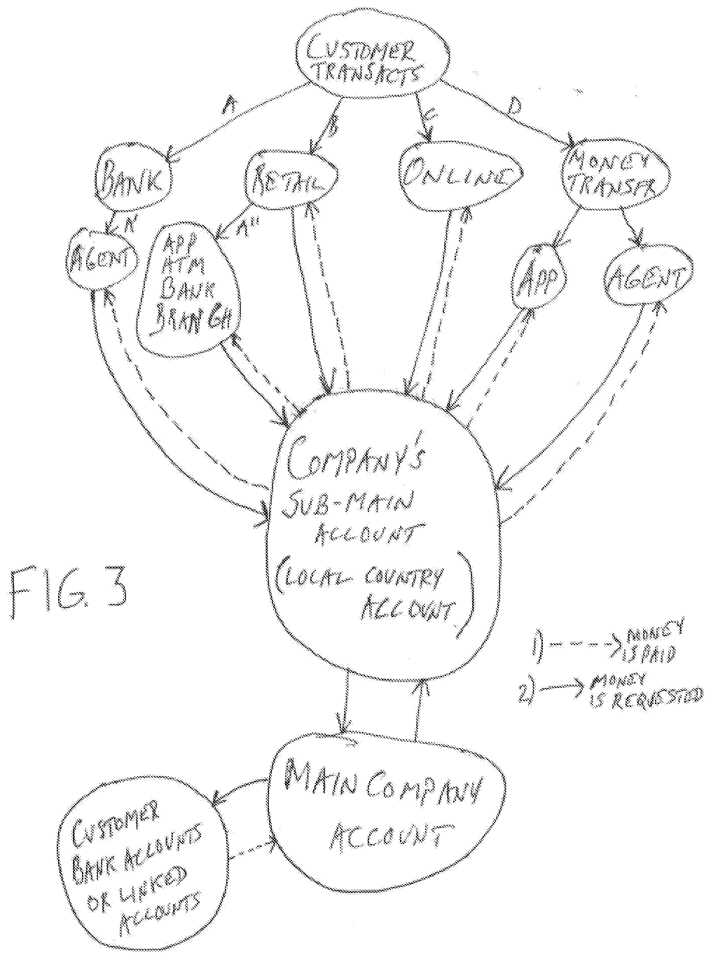

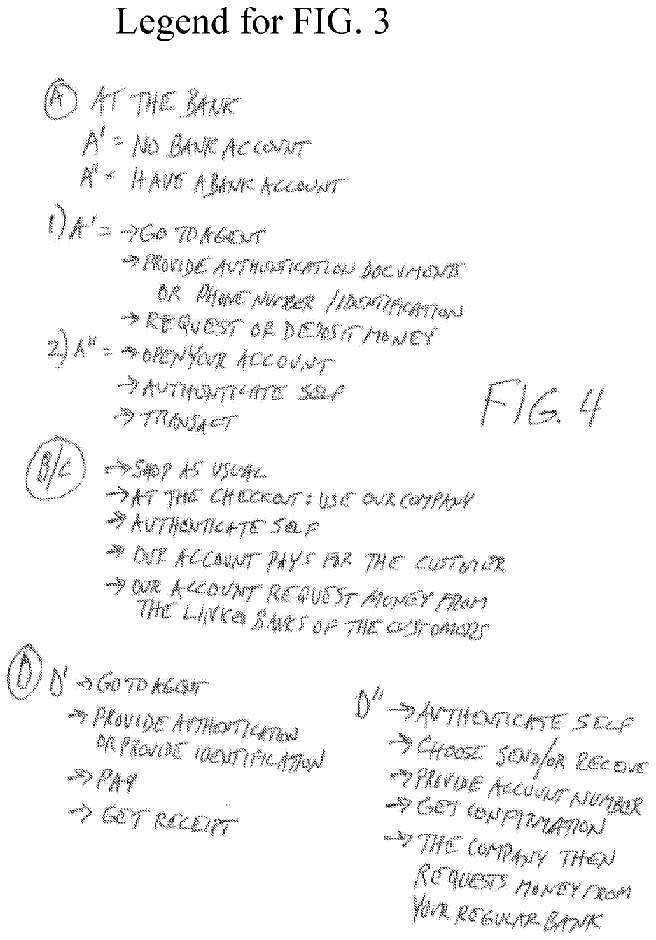

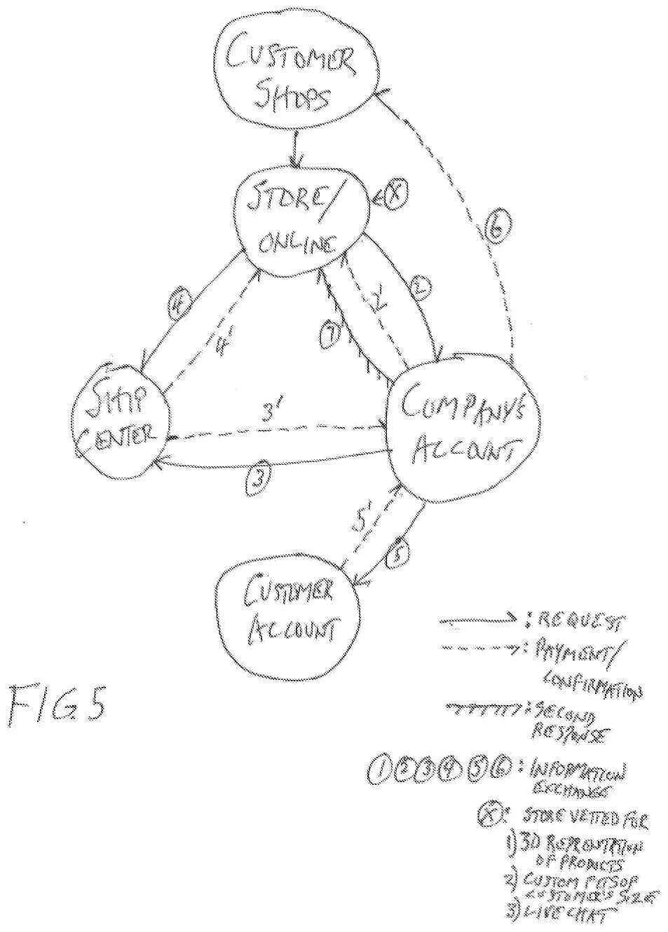

FIG. 3 is a process flow diagram illustrating how a customer executes various types of transactions. The application 104 described above would be in the control of the component shown as the “company” in FIG. 3. As illustrated, the application 104, on behalf of the company, would have local accounts (sub-main account) in countries where customers are located and would have a main company account that feeds funds to and receives transmissions from the local accounts. The main company account also deals with banks 112a-b as described above. FIG. 4 is a legend of terms for FIG. 3.

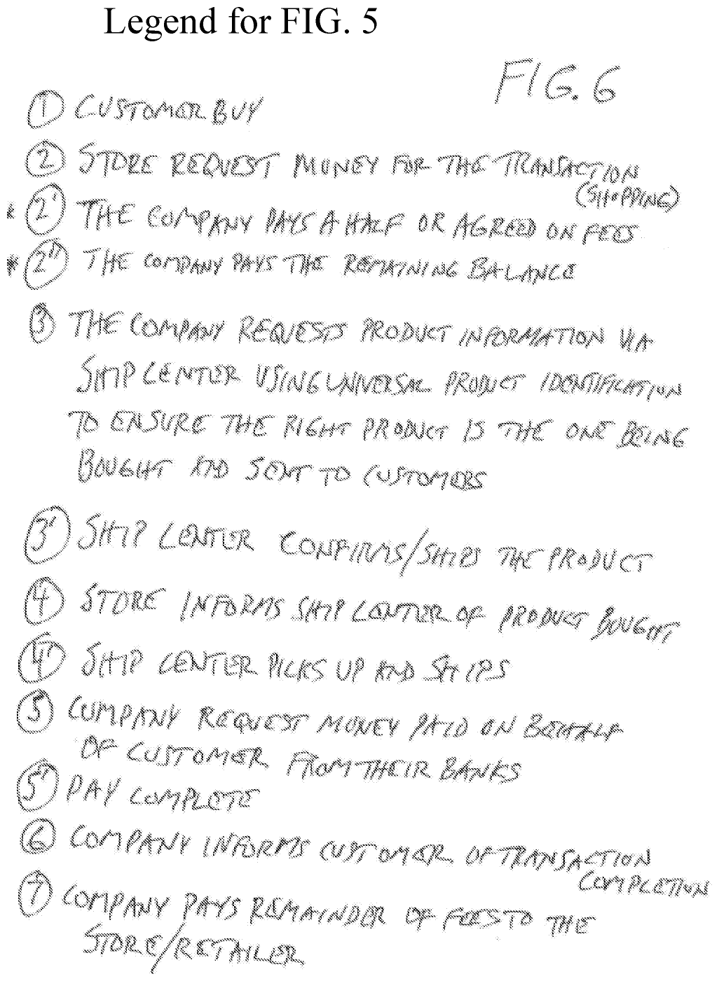

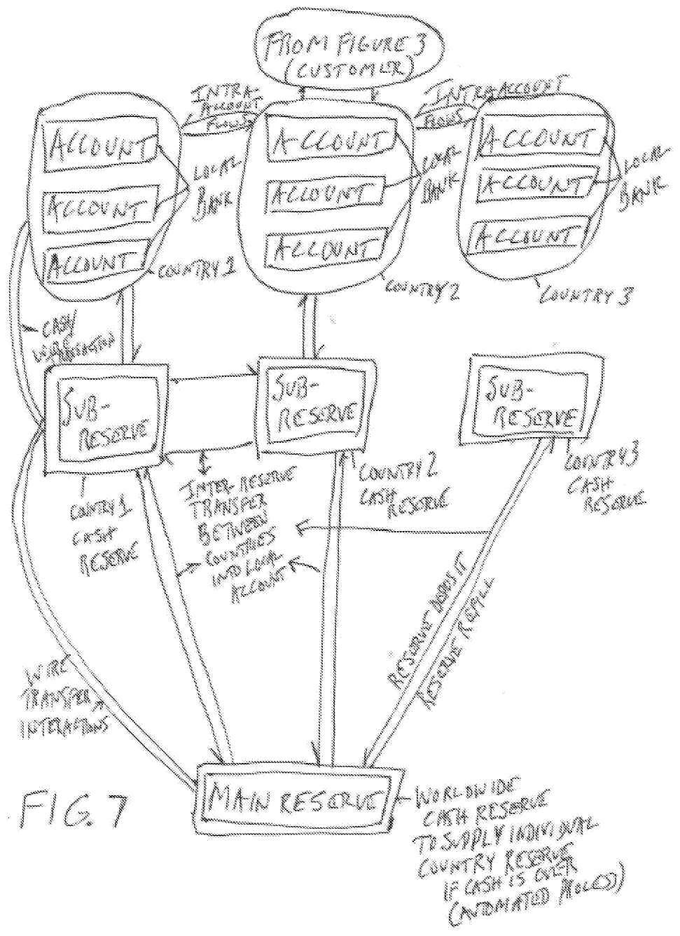

FIG. 5 is another process flow diagram illustrating activity and movement of funds and information between the parties described for FIG. 1. FIG. 6 is a legend for terminology for FIG. 5.

FIG. 7 is related to FIG. 3 and further illustrates flows of funds and communications when a transaction takes place. Local bank accounts in various countries in which a customer may reside feed funds to sub-reserve accounts which are similar to the local accounts or sub-main accounts shown in FIG. 3. Intra-account flows take place between the local bank accounts in the various countries. The sub-reserve accounts then feed funds to and receive funds from the main reserve account.

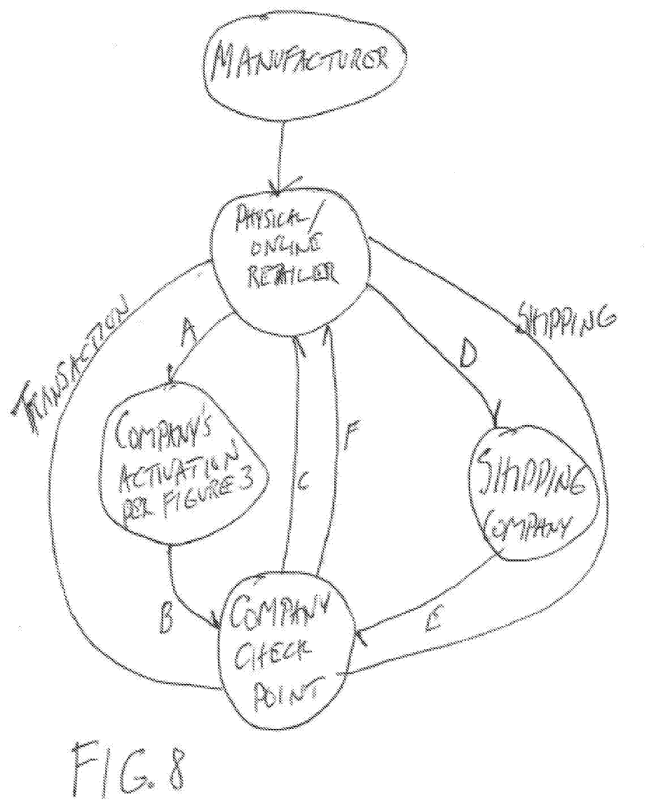

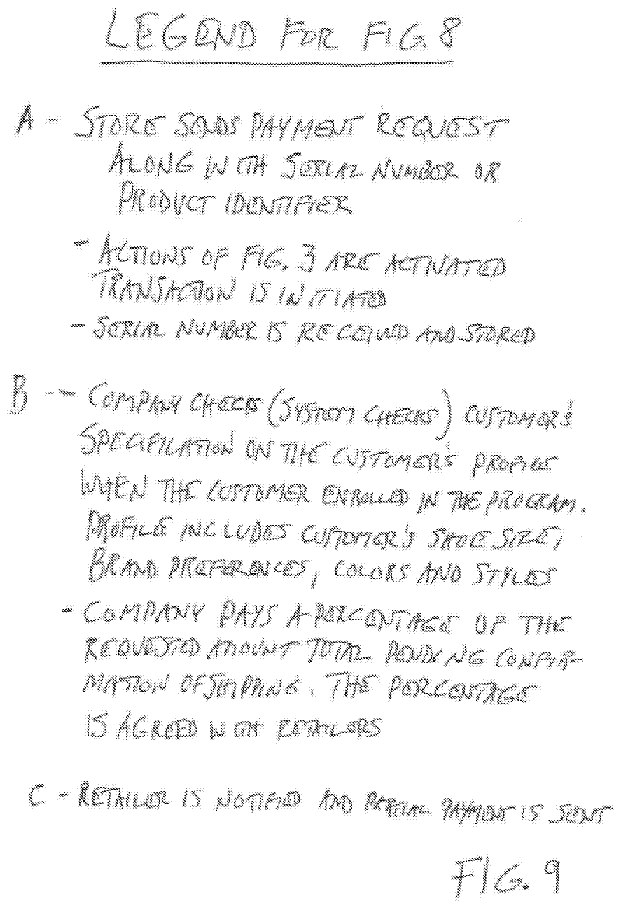

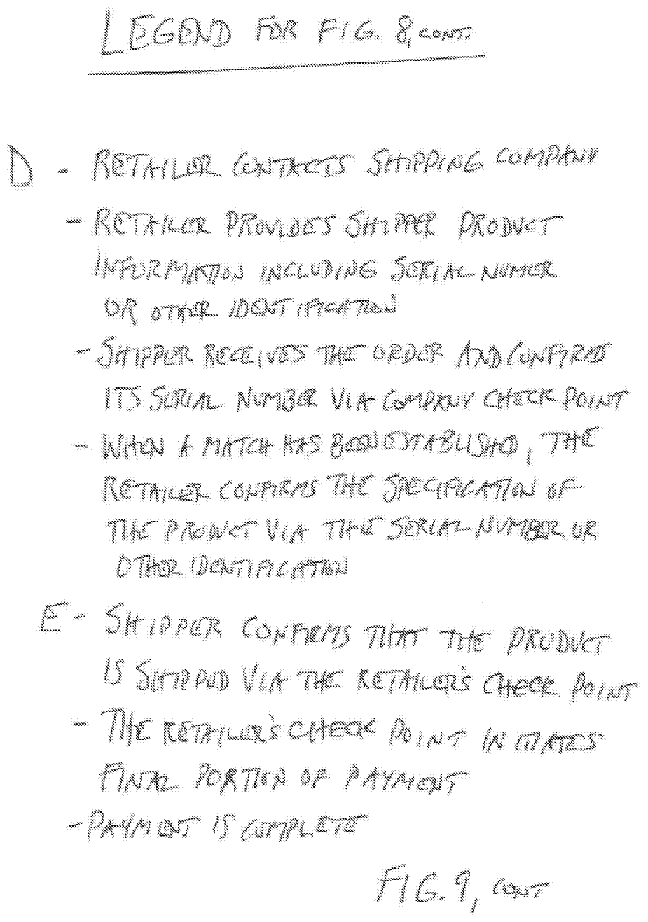

FIG. 8 is yet another process flow diagram illustrating actions and flows between a manufacturer, the application 104 (the company) of the system 100, the online retailer, and the shipping company. FIG. 9 provides a legend and details of the flows between the components.

1. A system for universal account, transfer, process, and authentication of a financial transaction, comprising
a processor;
a memory; and
an application stored in the memory that when executed on the processor:
receives a message from a client device associated with a customer seeking a product available from a plurality of online vendors,
locates the product in at least one database associated with at least one of the online vendors,
presents the product to the client device including identifying information about at least one vendor offering the product, and
processes purchase instructions received from the client device.

2. The system of claim 1, wherein the product is presented without bias in favor of or bias against any vendor.

3. The system of claim 1, wherein the application provides options based on customer preferences.

4. The system of claim 1, wherein the application searches the at least one database based on filters configured by the customer.

5. The system of claim 4, wherein the filters are configured upon enrollment in a program administered by the application and not during searching.

6. The system of claim 1, wherein the application tracks customer monetary amounts managed by the application as fiduciary on customers' behalf, the amounts held at multiple banks.

7. The system of claim 1, wherein when funding a vendor for a purchase by a customer, the application performs verification to ensure validity of customer and further requires involved banks to ensure said validity.

8. The system of claim 1, wherein a portion of amount owed under an online purchase is paid when the purchase instructions are processed.

9. The system of claim 8, wherein a remaining portion of the amount owed is paid upon one of shipment of product and confirmation by shipping company.

10. A method of universal account, transfer, process, and authentication of a financial transaction, comprising:
a computer receiving notification of a placement of a purchase order by a client device with an online retailer;
the computer remitting, on behalf of the client device, a first portion of a total price of the order to one of the retailer and a shipping company, the computer receiving notice that the order has shipped; and
the computer remitting, on behalf of the client device, a remainder of the total price to one of the retailer and the shipping company.

11. The method of claim 10, further comprising the computer tracking customer monetary amounts managed by the computer as fiduciary on customers' behalf, the amounts held at multiple banks.

12. The method of claim 10, further comprising the computer, when making remissions, performing verification to ensure validity of customer and further requiring involved banks to ensure said validity.

13. The method of claim 10, further comprising the computer providing a search function to the client device for locating online vendors of products.

14. The method of claim 13, further comprising the computer presenting results of the search function without bias for or against particular vendors.

15. A system for universal account, transfer, process, and authentication of a financial transaction, comprising
a processor;
a memory; and
an application stored in the memory that when executed on the processor:
tracks customer monetary amounts managed as fiduciary on customers' behalf, the amounts held at multiple banks,
while tracking the amounts, moves funds between banks to facilitate online transactions between customers and vendors,
when funding a vendor for a purchase by a customer, performs verification to ensure validity of customer and further requires involved banks to ensure said validity, and
enforces a waiting period between payment of vendor and drawing on customer amounts to address risk of fraud.

16. The system of claim 15, wherein the application provides a search function to the client device for locating online vendors of products.

17. The system of claim 16, wherein the application, in developing results of the search function, presents customers with unbiased listings of product availability from vendors.

18. The system of claim 15, wherein customers are issued cards that allow access to their monetary amounts overseen by the application.

19. The system of claim 15, wherein customers deposit funds into their accounts at agencies associated with the application when in locations not served by banks.

20. The system of claim 15, wherein customer accounts with the application are identified by telephone number.
